(19) United States
(12) Patent Application Publication
(10) Pub. No.: US 2017/0344262 A1
(43) Pub. Date: Nov. 30, 2017

(54) DATA PROCESSING SYSTEM AND METHOD FOR OPERATING THE SAME

(71) Applicant: SK hynix Inc., Gyeonggi-do (KR)

(72) Inventor: Do-Hyun KIM, Gyeonggi-do (KR)

(21) Appl. No.: 15/403,689

(22) Filed: Jan. 11, 2017

(30) Foreign Application Priority Data
May 25, 2016 (KR) 10-2016-0064085
May 25, 2016 (KR) 10-2016-0064168

(51) Int. Cl. G06F 3/06

(52) U.S. Cl. CPC G06F 3/0604; G06F 3/0683; G06F 3/0629; G06F 3/0659

(57) ABSTRACT

A data processing system includes: a host suitable for processing a plurality of tasks in parallel through a plurality of processors included therein, detecting write tasks that generate write data among the plurality of the tasks, and generating write process data which represent which one of the processors processes the respective write tasks; and a memory system suitable for storing the write data, which are processed by same one of the processors, into a plurality of memory devices thereof according to an interleaving scheme. The memory system determines based on the write process data whether the write data are processed by the same processor.

### CROSS-REFERENCE TO RELATED APPLICATIONS

The present application claims priority under 35 U.S.C. 119(a) to Korean Patent Applications No. 10-2016-0064085 and 10-2016-0064168, both filed on May 25, 2016, which are incorporated herein by reference in their entirety.

### BACKGROUND

### 1. Field

Exemplary embodiments of the present invention relate generally to semiconductor design technology and, more particularly, to a data processing system and a method for operating the data 15 processing system.

### 2. Description of the Related Art

The computer environment paradigm has changed to ubiquitous computing systems that can be used anytime and anywhere. Due to this fact, use of portable electronic devices such as mobile phones, digital cameras, and notebook computers has rapidly increased. These portable electronic devices generally use a memory system having memory devices for storing data. The memory system may be used as a main memory device or an auxiliary memory device of the portable electronic devices.

Memory systems using memory devices provide excellent stability, durability, high information access speed, and low power consumption, since they have no moving parts. Examples of memory systems having such advantages include universal serial bus (USB) memory devices, memory cards having various interfaces, and solid state drives (SSD).

### SUMMARY

Embodiments of the present invention are directed to a data processing system capable of defining physical storage positions of write data based on an operation processor. The data processing system is capable of processing a plurality of tasks in parallel.

According to an embodiment of the present invention, a data processing system, may include: a host suitable for processing a plurality of tasks in parallel through a plurality of processors included therein, detecting write tasks that generate write data among the plurality of the tasks, and generating write process data which represent which one of the processors processes the respective write tasks; and a memory system suitable for storing the write data, which are processed by same one of the processors, into a plurality of memory devices thereof according to an interleaving scheme. The memory system determines based on the write process data whether the write data are processed by the same processor.

The respective write process data may be included in a write commands generated by the host.

The plurality of the memory devices may be divided into N memory device groups respectively coupled to N channels. The memory system may store the write data, which are processed by the same processor, into the memory devices of different ones among the N memory device groups according to an interleaving scheme.

The host may store the write process data in a part of a main memory used for internal data thereof.

The plurality of the memory devices may be divided into N memory device groups respectively coupled to N channels. The memory system may store the write data, which are processed by the same processor, into the memory devices of different ones among the N memory device groups according to an interleaving scheme.

According to another embodiment of the present invention, a method for operating a data processing system comprising a host including a plurality of processors, and a memory system including a plurality of memory devices, the method may include: processing, by the host, a plurality of tasks in parallel through the processors; detecting, by the host, write tasks that generate write data among the plurality of the tasks; generating, by the host, write process data that represent which one of the processors processes the respective write tasks; and storing, by the memory system, the write data, which are processed by same one of the processors, into a plurality of memory devices thereof according to an interleaving scheme,

The storing of the write data may include determining based on the write process data whether the write data are processed by the same processor.

The respective write process data may be included in a write commands generated by the host.

The plurality of the memory devices may be divided into N memory device groups respectively coupled to N channels. The storing of the write data, which are processed by same one of the processors, may be performed to the memory devices of different ones among the N memory device groups according to an interleaving scheme.

The method may further include storing, by the host, the write process data in a part of a main memory used for internal data of the host.

The plurality of the memory devices may be divided into N memory device groups respectively coupled to N channels. The storing of the write data, which are processed by same one of the processors, may be performed to the memory devices of different ones among the N memory device groups according to an interleaving scheme.

According to yet another embodiment of the present invention, a data processing system, may include: a host suitable for processing a plurality of tasks in parallel through a plurality of processors included therein, detecting write tasks that generate write data among the plurality of the tasks, and generating write process data which represent which one of the processors processes the respective write tasks; and a memory system suitable for storing the write data and the write process data by a unit of a pair of the write data and the corresponding write process data randomly in a plurality of memory devices thereof, and then re-storing the write data, which are processed by same one of the processors, into the memory devices according to an interleaving scheme during a background operation. The memory system may determine based on the write process data whether the write data are processed by the same processor.

The respective write process data may be included in a write commands generated by the host.

The plurality of the memory devices may be divided into N memory device groups respectively coupled to N channels. The memory system may store the write data, which are processed by the same processor, into the memory devices of different ones among the N memory device groups according to an interleaving scheme.

The host may store the write process data in a part of a main memory used for internal data thereof.

The host may provide the write data to the memory system while storing the write data in the part of the main memory. The memory system may store the write data and the write process data randomly in the memory devices by reading the write process data from the part of the main memory, and then may re-store the write data, which are processed by same one of the processors, into the memory devices according to the interleaving scheme during the background operation.

The plurality of the memory devices may be divided into N memory device groups respectively coupled to N channels. The memory system may store the write data, which are processed by the same processor, into the memory devices of different ones among the N memory device groups according to an interleaving scheme.

The background operation may be one of a garbage collection operation, a wear leveling operation, or a data defragmentation operation.

According to still another embodiment of the present invention, a method for operating a data processing system comprising a host including a plurality of processors, and a memory system including a plurality of memory devices, the method may include: processing, by the host, a plurality of tasks in parallel through the processors; detecting, by the host, write tasks that generate write data among the plurality of the tasks; generating, by the host, write process data that represent which one of the processors processes the respective write tasks; storing, by the memory system, the write data and the write process data by a unit of a pair of the write data and the corresponding write process data randomly in the memory devices; and re-storing, by the memory system, the write data, which are processed by same one of the processors, into the memory devices according to an interleaving scheme during a background operation. The re-storing of the write data may include determining based on the write process data whether the write data are processed by the same processor.

The respective write process data may be included in a write commands generated by the host.

The plurality of the memory devices may be divided into N memory device groups respectively coupled to N channels. The re-storing of the write data, which are processed by same one of the processors, may be performed to the memory devices of different ones among the N memory device groups according to an Interleaving scheme.

The method may further include storing, by the host, the write process data in a part of a main memory used for internal data of the host.

The method may further comprising include, by the host, the write data to the memory system while storing, by the host, the write data in the part of the main memory. The storing of the write data and the write process data randomly in the memory devices may include reading, by the memory system, the write process data from the part of the main memory.

The plurality of the memory devices may be divided into N memory device groups respectively coupled to N channels. The re-storing of the write data, which are processed by the same processor, may be performed to the memory devices of different ones among the N memory device groups according to an interleaving scheme.

The background operation may be one of a garbage collection operation, a wear leveling operation, or a data defragmentation operation.

### BRIEF DESCRIPTION OF THE DRAWINGS

Various embodiments of the present invention will be described in reference to the accompanying drawings, wherein,

FIG. 1 is a diagram illustrating a data processing system including a memory system coupled to a host, according to an embodiment of the present invention;

FIG. 2 is a diagram illustrating a memory device employed in the data processing system of FIG. 1;

FIG. 3 is a diagram illustrating a memory block of the memory device of FIG. 1;

FIG. 4 is a diagram illustrating a three-dimensional structure of the memory device of FIG. 1;

FIG. 5 illustrates an example of an operation of the host of FIG. 1, according to an embodiment of the present invention;

FIG. 6 illustrates an operation of a memory system of FIG. 1, according to an embodiment of the present invention;

FIG. 7 illustrates an operation between the host and the memory system of FIG. 1, according to an embodiment of the present invention;

FIG. 8 illustrates an operation between the host and the memory system of FIG. 1, according to an embodiment of the present invention;

FIG. 9 illustrates an operation of the memory system of FIG. 1, according to an embodiment of the present invention;

FIG. 10 illustrates an operation between the host and the memory system of FIG. 1, according to an embodiment of the present invention;

FIG. 11 illustrates an operation between the host and the memory system of FIG. 1, according to an embodiment of the present invention;

FIG. 12 is a diagram illustrating a memory card system including a memory system, according to an embodiment of the present invention;

FIG. 13 is a diagram illustrating a data processing system including a memory system, according to an embodiment of the present invention;

FIG. 14 is a diagram illustrating a solid state drive including a memory system, according to an embodiment of the present invention;

FIG. 15 is a diagram illustrating an embedded multimedia drive including a memory system, according to an embodiment of the present invention;

FIG. 16 is a diagram illustrating a universal flash drive including a memory system, according to an embodiment of the present invention; and

FIG. 17 is a diagram illustrating a user system including a memory system, according to an embodiment of the present invention.

### DETAILED DESCRIPTION

Although, various embodiments are described below in more detail with reference to the accompanying drawings, we note that the present invention may, however, be embodied in different forms and should not be construed as being limited to an embodiment set forth herein. Rather, the described embodiments are provided so that this disclosure will be thorough and complete, and will fully convey the present invention to those skilled in the art to which this invention pertains. Throughout the disclosure, like reference numerals refer to like parts throughout the various figures and embodiments of the present invention.

It will be understood that, although the terms “first”, “second”, “third”, and so on may be used herein to describe various elements, these elements are not limited by these terms. These terms are used to distinguish one element from another element. Thus, a first element described below could also be termed as a second or third element without departing from the spirit and scope of the present invention.

The drawings are not necessarily to scale and, in some instances, proportions may have been exaggerated in order to clearly illustrate features of an embodiment.

It will be further understood that when an element is referred to as being “connected to”, or “coupled to” another element, it may be directly on, connected to, or coupled to the other element, or one or more intervening elements may be present. In addition, it will also be understood that when an element is referred to as being “between” two elements, it may be the only element between the two elements, or one or more intervening elements may also be present.

The terminology used herein is for the purpose of describing particular embodiments only and is not intended to be limiting of the present invention. As used herein, singular forms are intended to include the plural forms as well, unless the context clearly indicates otherwise. It will be further understood that the terms “comprises,” “comprising,” “Includes,” and “including” when used in this specification, specify the presence of the stated elements and do not preclude the presence or addition of one or more other elements. As used herein, the term “and/or” includes any and all combinations of one or more of the associated listed items.

Unless otherwise defined, all terms including technical and scientific terms used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In the following description, numerous specific details are set forth in order to provide a thorough understanding of the present invention. The present invention may be practiced without some or all of these specific details. In other instances, well-known process structures and/or processes have not been described in detail in order not to unnecessarily obscure the present invention.

It is also noted, that in some instances, as would be apparent to those skilled in the relevant art, a feature or element described in connection with one embodiment may be used singly or in combination with other features or elements of another embodiment, unless otherwise specifically indicated.

Hereinafter, the various embodiments of the present invention will be described in detail with reference to the attached drawings.

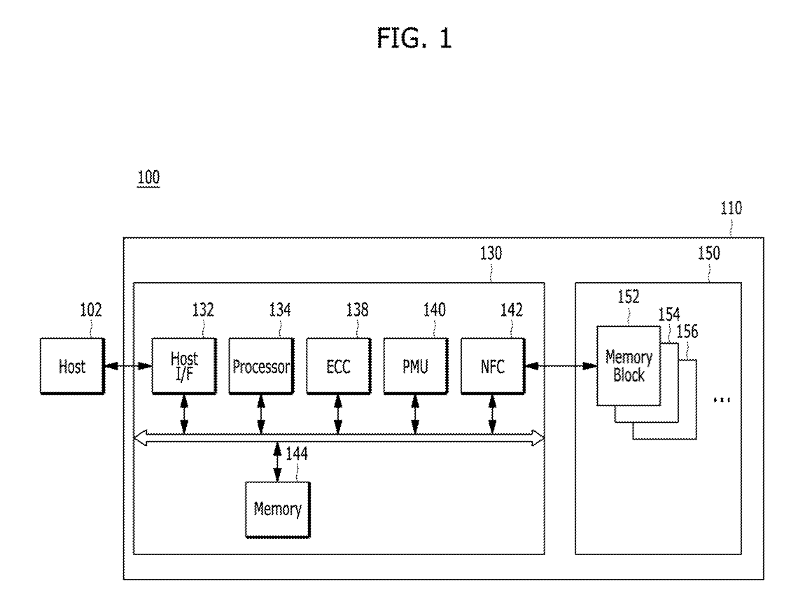

Referring now to FIG. 1 a data processing system 100 is provided, according to an embodiment of the present invention.

The data processing system 100 may include a memory system 110 operatively coupled to a host 102.

For example, the host 102 may include a portable electronic device such as a mobile phone, an MP3 player and a laptop computer or a non-portable electronic device such as a desktop computer, a game player, a television (TV) and a projector.

The memory system 110 may operate in response to a request received from the host 102. For example, the memory system 110 may store data provided by the host 102 in response to a program request (also referred to as a write request) received from the host 102. The stored data may be accessed by the host 102 in response to a read request received from the host 102. The memory system 110 may be used as a main memory system or an auxiliary memory system of the host 102. The memory system 110 may be implemented with any one of various storage devices, according to the protocol of a host interface to be coupled electrically with the host 102. The memory system 110 may be implemented with any one of various storage devices, such as a solid state drive (SSD), a multimedia card (MMC), an embedded MMC (eMMC), a reduced size MMC (RS-MMC) and a micro-MMC, a secure digital (SD) card, a mini-SD and a micro-SD, a universal serial bus (USB) storage device, a universal flash storage (UFS) device, a compact flash (CF) card, a smart media (SM) card, a memory stick, and the like.

The storage devices for the memory system 110 may be implemented with a volatile memory device, such as, a dynamic random access memory (DRAM) and a static random access memory (SRAM) or a nonvolatile memory device such as a read only memory (ROM), a mask ROM (MROM), a programmable ROM (PROM), an erasable programmable ROM (EPROM), an electrically erasable programmable ROM (EEPROM), a ferroelectric random access memory (FRAM), a phase change RAM (PRAM), a magnetoresistive RAM (MRAM) and a resistive RAM (RRAM).

The memory system 110 may include a memory device 150 operatively coupled to a controller 130. The memory device 150 may store data to be accessed by the host 102. The controller 130 may control the storage of the data in the memory device 150.

The controller 130 and the memory device 150 may be integrated into a single semiconductor device. For instance, the controller 130 and the memory device 150 may be integrated into a single semiconductor device configured as a solid state drive (SSD). When the memory system 110 is integrated as a SSD, the operation speed of the host 102 that is electrically coupled with the memory system 110 may be significantly increased.

The controller 130 and the memory device 150 may be integrated into a single semiconductor device configured as a memory card, such as a Personal Computer Memory Card International Association (PCMCIA) card, a compact flash (CF) card, a smart media (SM) card (SMC), a memory stick, a multimedia card (MMC), an RS-MMC and a micro-MMC, a secure digital (SD) card, a mini-SD, a micro-SD and an SDHC, and a universal flash storage (UFS) device.

For another instance, the memory system 110 may be configured as a memory system of any one of a computer, an ultra-mobile PC (UMPC), a workstation, a net-book, a personal digital assistant (PDA), a portable computer, a web tablet, a tablet computer, a wireless phone, a mobile phone, a smart phone, an e-book, a portable multimedia player (PMP), a portable game player, a navigation device, a black box, a digital camera, a digital multimedia broadcasting (DMB) player, a three-dimensional (3D) television, a smart television, a digital audio recorder, a digital audio player, a digital picture recorder, a digital picture player, a digital video recorder, a digital video player, a storage configuring a data center, a device capable of transmitting and receiving information under a wireless environment, one of various electronic devices configuring a home network, one of various electronic devices configuring a computer network, one of various electronic devices configuring a telematics network, an RFID device, or one of various component elements configuring a computing system.

The memory device 150 of the memory system 110 may retain stored data when power supply to the device is interrupted. In particular, the memory device 150 may store the data provided from the host 102 during a write operation, and provide stored data to the host 102 during a read operation. The memory device 150 may include a plurality of memory blocks 152, 154 and 156. Each of the memory blocks 152, 154 and 156 may include a plurality of pages. Each of the pages may include a plurality of memory cells electrically coupled to a word line. The memory device 150 may be a nonvolatile memory device such as a flash memory. The memory device 150 may have a three-dimensional (3D) stack structure. The memory device may be a NAND flash memory.

The controller 130 of the memory system 110 may control the memory device 150 in response to a request from the host 102. The controller 130 may provide data read from the memory device 150 to the host 102. The controller 130 may also store data provided from the host 102 in the memory device 150. To this end, the controller 130 may control the basic operations of the memory device 150, such as read, write, program and erase operations. The controller may also control the background operations of the memory device 150.

According to the embodiment of FIG. 1, the controller 130 may include a host interface unit 132, a processor 134, an error correction code (ECC) unit 138, a power management unit (PMU) 140, a NAND flash controller (NFC) 142, and a memory 144.

The host interface unit 132 may process commands, addresses and data provided from the host 102, and may provide read data to the host 102. The host interface 102 may communicate with the host 102 through at least one of various interface protocols such as a universal serial bus (USB), a multimedia card (MMC), a peripheral component interconnect-express (PCI-E), a serial attached SCSI (SAS), a serial advanced technology attachment (SATA), a parallel advanced technology attachment (PATA), a small computer system interface (SCSI), an enhanced small disk interface (ESDI), and an integrated drive electronics (IDE).

The ECC unit 138 may detect and correct errors in the data read from the memory device 150 during a read operation. The ECC unit 138 may not correct error bits when the number of the error bits is greater than or equal to a threshold number of correctable error bits, and may output an error correction fail signal indicating failure in correcting the error bits.

The ECC unit 138 may perform an error correction operation based on any one of well-known coded modulation schemes such as a low density parity check (LDPC) code, a Bose-Chaudhuri-Hocquenghem (BCH) code, a turbo code, a Reed-Solomon (RS) code, a convolution code, a recursive systematic code (RSC), a trellis-coded modulation (TCM), a Block coded modulation (BCM), and so on. The ECC unit 138 may include all circuits, systems or devices for performing the error correction operation.

The PMU 140 may provide and manage power for the controller 130, that is, power for the component elements included in the controller 130.

The NFC 142 is an example of a memory interface between the controller 130 and the memory device 150 for allowing the controller 130 to control the memory device 150 in response to a request from the host 102. The NFC 142 may generate control signals for the memory device 150 and process data under the control of the processor 134 when the memory device 150 is a flash memory. In particular, the NFC 142 may generate control signals for the memory device 150 and process data under the control of the processor 134 when the memory device 150 is a NAND flash memory. Any suitable memory interface may be employed depending upon the type of the memory device employed.

The memory 144 may serve as a working memory of the memory system 110 and the controller 130, and store data for driving the memory system 110 and the controller 130. The controller 130 may control the memory device 150 in response to a request from the host 102. For example, the controller 130 may provide the data read from the memory device 150 to the host 102 and store the data provided from the host 102 in the memory device 150. When the controller 130 controls the operations of the memory device 150, the memory 144 may store data used by the controller 130 and the memory device 150 for such operations as read, write, program and erase operations.

The memory 144 may be implemented with volatile memory. The memory 144 may be implemented with a static random access memory (SRAM) or a dynamic random access memory (DRAM). As described above, the memory 144 may store data used by the host 102 and the memory device 150 for the read and write operations. To store the data, the memory 144 may include a program memory, a data memory, a write buffer, a read buffer, a map buffer, and so forth.

The processor 134 may control one or more operations of the memory system 110, including a write operation, a read operation and an erase operation for the memory device 150, in response to a write, read or an erase request from the host 102, respectively. The processor 134 may drive firmware, which is referred to as a flash translation layer (FTL), to control the operations of the memory system 110. The processor 134 may be implemented with a microprocessor or a central processing unit (CPU).

A management unit (not shown) may be included in the processor 134, and may perform bad block management of the memory device 150. The management unit may find bad memory blocks included in the memory device 150, which are in unsatisfactory condition for further use, and perform bad block management on the bad memory blocks. When the memory device 150 is a flash memory, such as a NAND flash memory, a program failure may occur during the write operation (or program operation), due to characteristics of a NAND logic function. During the bad block management, the data of the program-failed memory block or the bad memory block may be programmed into a new memory block. Also, the bad blocks due to the program fail seriously deteriorates the utilization efficiency of the memory device 150 having a 3D stack structure and the reliability of the memory system 100, and thus reliable bad block management is typically employed.

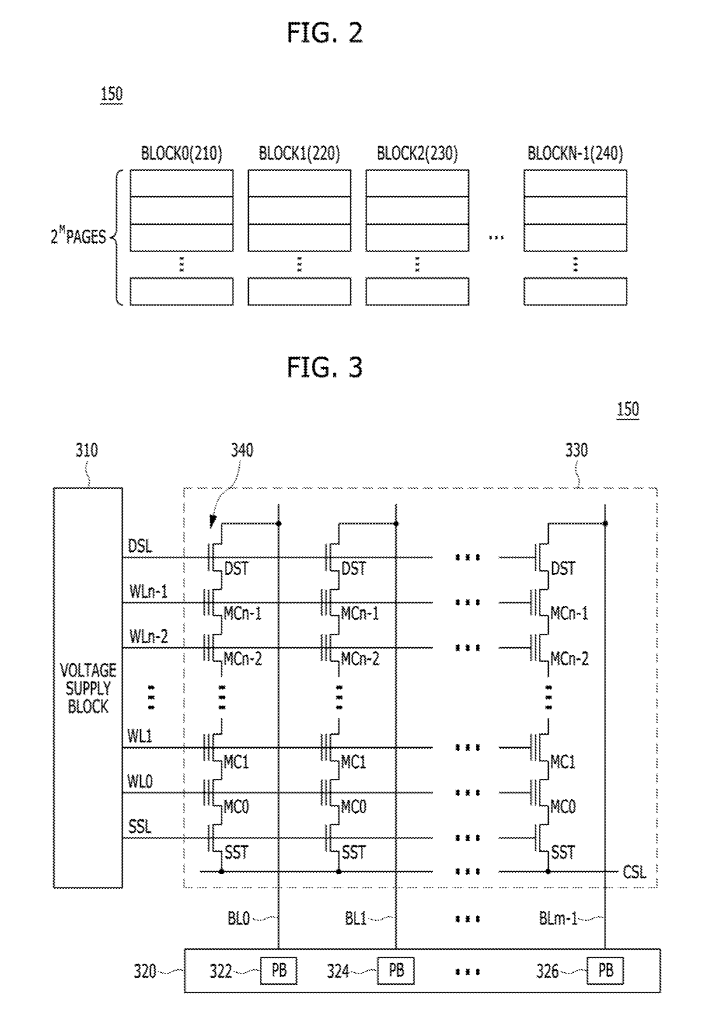

FIG. 2 illustrates a configuration of the memory device 150 of FIG. 1, according to an embodiment of the present invention.

Referring to FIG. 2, the memory device 150 may include a plurality of memory blocks. For example, the memory device 150 may include zeroth to (N−1)^{th} blocks 210 to 240. Each of the plurality of memory blocks 210 to 240 may include a plurality of pages. For example, each of the plurality of memory blocks 210 to 240 may include 2^{M} number of pages (2^{M} PAGES), to which the present invention will not be limited. Each of the plurality of pages may include a plurality of memory cells to which a word line is electrically coupled.

Also, the memory device 150 may include a plurality of memory blocks, as single level cell (SLC) memory blocks and multi-level cell (MLC) memory blocks, according to the number of bits which may be stored or expressed in each memory cell. The SLC memory block may include a plurality of pages which are implemented with memory cells each capable of storing 1-bit data. The MLC memory block may include a plurality of pages which are implemented with memory cells each capable of storing multi-bit data, for example, two or more-bit data. An MLC memory block including a plurality of pages which are implemented with memory cells that are each capable of storing 3-bit data may be defined as a triple level cell (TLC) memory block.

Each of the plurality of memory blocks 210 to 240 may store the data provided from the host 102 during a write operation, and may provide stored data to the host 102 during a read operation.

FIG. 3 is a diagram illustrating one of the plurality of memory blocks 152 to 156 of FIG. 1.

Referring to FIG. 3, the memory block 152 of the memory device 150 may include a plurality of cell strings 340 which are realized into a memory cell array and are coupled to bit lines BL0 to BLm-1, respectively. Each of the cell strings 340 of each column may include at least one drain select transistor DST and at least one source select transistor SST. In each cell string 340, a plurality of memory cells or memory cell transistors MC0 to MCn-1 may be coupled in series between the source select transistor SST and the drain select transistor DST. The respective memory cells MC0 to MCn-1 may be constructed by multi-level cells (MLC) each of which stores information of a plurality of bits. Each cell string 340 may be electrically coupled between a common source line CSL and a respective bit line among the plurality of bit lines BL0 to BLm-1. The gate of the source select transistor SST of each cell string 340 is coupled to a common source select line SSL. The gate of the drain select transistor DST of each cell string 340 is coupled to a common drain select line DSL. The gates of the memory cells MC0 to MCn-1 of each cell string 340 are coupled to different word lines WL0 to WLn-1 respectively. Memory cells having their gates coupled to the same word line form a page.

While FIG. 3 shows the memory block 152 which is constructed by NAND flash memory cells, it is to be noted that the memory block 152 of the memory device 150 according to the embodiment is not limited to a NAND flash memory and may be realized by a NOR flash memory, a hybrid flash memory in which at least two kinds of memory cells are combined or a one-NAND flash memory in which a controller is built in a memory chip. The operational characteristics of a semiconductor device may be applied to not only a flash memory device in which a charge storing layer is constructed by conductive floating gates but also a charge trap flash (CTF) in which a charge storing layer is constructed by a dielectric layer.

A voltage supply block 310 of the memory device 150 may provide word line voltages (for example, a program voltage, a read voltage and a pass voltage) to be supplied to respective word lines according to an operation mode and voltages to be supplied to bulks (for example, well regions) formed with memory cells. The voltage generating operation of the voltage supply block 310 may be performed by the control of a control circuit (not shown). The voltage supply block 310 may generate a plurality of variable read voltages to generate a plurality of read data, select one of the memory blocks (or sectors) of a memory cell array in response to the control of the control circuit, select one of the word lines of the selected memory block, and provide the word line voltages to the selected word line and unselected word lines.

A read/write circuit 320 of the memory device 150 is controlled by the control circuit, and may operate as a sense amplifier or a write driver according to an operation mode. For example, in the case of a verify/normal read operation, the read/write circuit 320 may operate as a sense amplifier for reading data from the memory cell array. Also, in the case of a program operation, the read/write circuit 320 may operate as a write driver which drives bit lines according to data to be stored in the memory cell array. In the program operation, the read/write circuit 320 may receive data to be written in the memory cell array, from a buffer (not shown), and may drive the bit lines according to inputted data. To this end, the read/write circuit 320 may include a plurality of page buffers (PB) 322, 324 and 326 respectively corresponding to columns (or bit lines) or pairs of columns (or pairs of bit lines), and a plurality of latches (not shown) may be included in each of the page buffers 322, 324 and 326.

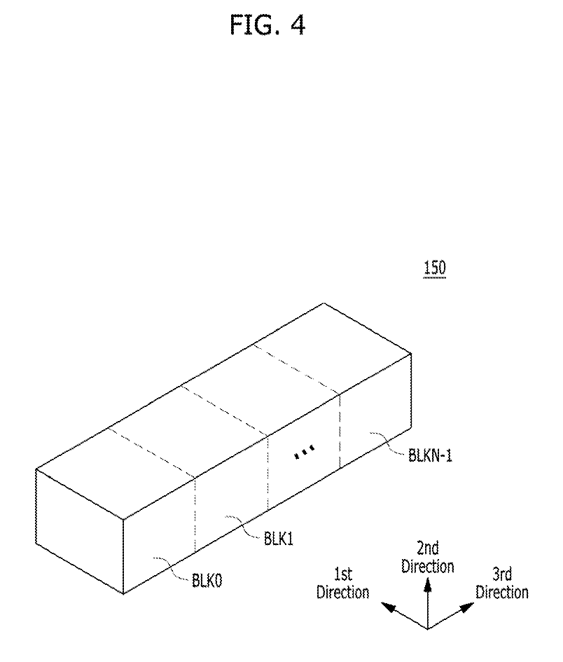

FIG. 4 illustrates a 3D-structure of the memory device 150 of FIG. 1, according to an embodiment of the present invention.

The memory device 150 may be realized as a 2-dimensional or 3-dimensional memory device. In particular, as shown in FIG. 4, in the case where the memory device 150 is realized as a 3-dimensional (or a vertical) nonvolatile memory device, the memory device 150 may include a plurality of memory blocks BLK0 to BLKN-1.

For example, the respective memory blocks BLK0 to BLKN-1 may each be realized as a 3-dimensional structure by including a structure which extends in first to third directions (e.g., the x-axis direction, the y-axis direction and the z-axis direction).

Referring to FIGS. 3 and 4, the respective memory blocks BLK0 to BLKN-1 included in the memory device 150 may include a plurality of cell strings 340 (e.g. NAND strings NS as illustrated in FIG. 3) each cell string extending in a second direction. The second direction as shown in FIG. 4 may be a vertical direction. A plurality of vertical cell strings 340 may be spaced apart along the first direction and the third direction creating a 3-D structure. Each cell string 340 may be configured as illustrated in FIG. 3. Hence, each cell string may coupled to a respective bit line BL and a common source line CSL.

Namely, among the plurality of memory blocks of the memory device 150, the respective memory blocks BLK may be coupled to a plurality of bit lines BL, a plurality of drain select lines, a plurality of source select lines SSL, a plurality of word lines WL, a plurality of dummy word lines DWL and a plurality of common source lines CSL, and accordingly, may include a plurality of NAND strings NS. Also, in the respective memory blocks BLK, a plurality of NAND strings NS may be coupled to one bit line BL, and a plurality of transistors may be realized in one NAND string NS. A drain select transistor DST of each NAND string NS may be coupled to a corresponding bit line BL, and a source select transistor SST of each NAND string NS may be coupled to the common source line CSL. Memory cells MC may be provided between the drain select transistor DST and the source select transistor SST of each NAND string NS. Namely, in the plurality of memory blocks of the memory device 150, a plurality of memory cells may be realized in each of the memory blocks BLK.

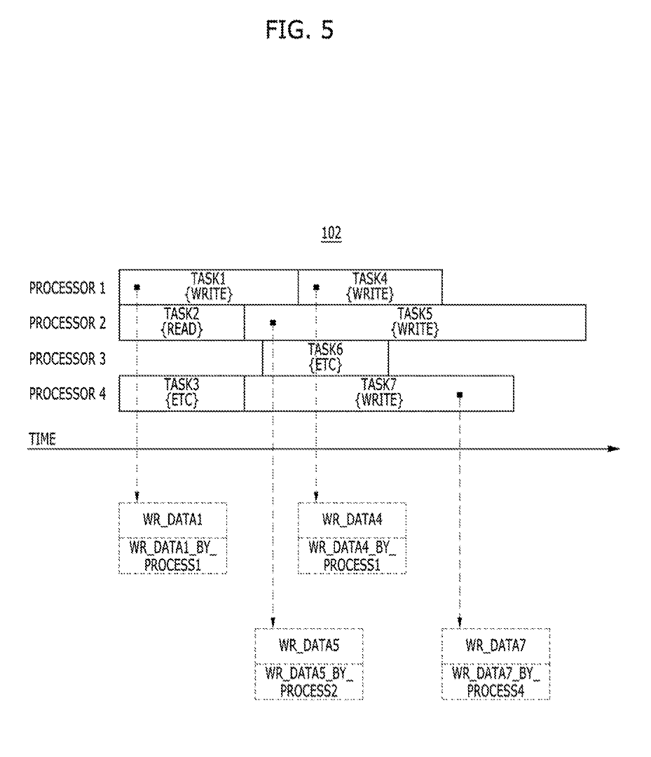

FIG. 5 illustrates an example of an operation of the host 102 of FIG. 1.

Referring to FIG. 5, the host 102 includes a plurality of processors, for example, first to fourth processors PROCESS1 to PROCESS4.

The processors PROCESS1 to PROCESS4 may simultaneously process a plurality of tasks in parallel. A task may be a read or a write request for example.

FIG. 5 exemplifies the first processor PROCESS1 processing a first task TASK1{WRITE} while the second processor PROCESS2 is processing a second task TASK2{READ} and the fourth processor PROCESS4 is processing a third task TASK3{ETC}. As illustrated in FIG. 5, the first task TASK1{WRITE}, the second task TASK2{READ}, and the third task TASK3{ETC} may be processed in parallel.

Also, FIG. 5 exemplifies the first processor PROCESS1 processing a fourth task TASK4{WRITE} while the second processor PROCESS2 is processing a fifth task TASK5{WRITE}, the third processor PROCESS3 is processing sixth task TASK6{ETC} and the fourth processor PROCESS4 is processing a seventh task TASK7{WRITE}. The fourth task TASK4{WRITE}, the fifth task TASK5{WRITE}, the sixth task TASK6{ETC} and the seventh task TASK7{WRITE} may be processed in parallel.

According to the write tasks TASK1{WRITE}, TASK4{WRITE}, TASK5{WRITE}, and TASK7{WRITE} among the tasks TASK1{WRITE}, TASK2{READ}, TASK3{ETC}, TASK4{WRITE}, TASK5{WRITE}, TASK6{ETC} and TASK7{WRITE}, write data WR_DATA1, WR_DATA4, WR_DATA5 and WR_DATA7 may be generated and transferred to the memory system 110, respectively, so that the write data WR_DATA1, WR_DATA4, WR_DATA5 and WR_DATA7 are stored in the memory system 110.

Herein, the host 102 generates write process data WR_DATA1-BY-PROCESS1, WR_DATA4-BY-PROCESS1, WR_DATA5-BY-PROCESS2 and WR_DATA7-BY-PROCESS4 for identifying the respective write data and corresponding processor processing corresponding one among the write task TASK1{WRITE}, TASK4{WRITE}, TASK5{WRITE} and TASK7{WRITE}.

To be specific, the host 102 generates a first process data WR_DATA1 by PROCESS1 representing that the first task TASK1{WRITE} is processed by the first processor PROCESS1, the second process data WR_DATA4 by PROCESS1 representing that the fourth task TASK4{WRITE} Is processed by the first processor PROCESS1, the third process data WR_DATA5 by PROCESS2 representing that the fifth task TASK5{WRITE} Is processed by the second processor PROCESS2, and the fourth process data WR_DATA7 by PROCESS4 representing that the seventh task TASK7{WRITE} is processed by the fourth processor PROCESS4.

Remaining tasks TASK2{READ}, TASK3{ETC} and TASK6{ETC} other than the write tasks TASK1{WRITE}, TASK4{WRITE}, TASK5{WRITE}, and TASK7{WRITE} among the tasks TASK1{WRITE}, TASK2{READ}, TASK3{ETC}, TASK4{WRITE}, TASK5{WRITE}, TASK6{ETC} and TASK7{WRITE} are not related to a write operation of the memory system 110, and thus there is no need to generate write data.

The host 102 includes four processors PROCESS1, PROCESS2, PROCESS3 and PROCESS4 in this embodiment of the present invention, but this is a mere example and it is obvious to those skilled in the art that the host 102 may include more than four processors or less than four processors as long as there are at least two or more processors.

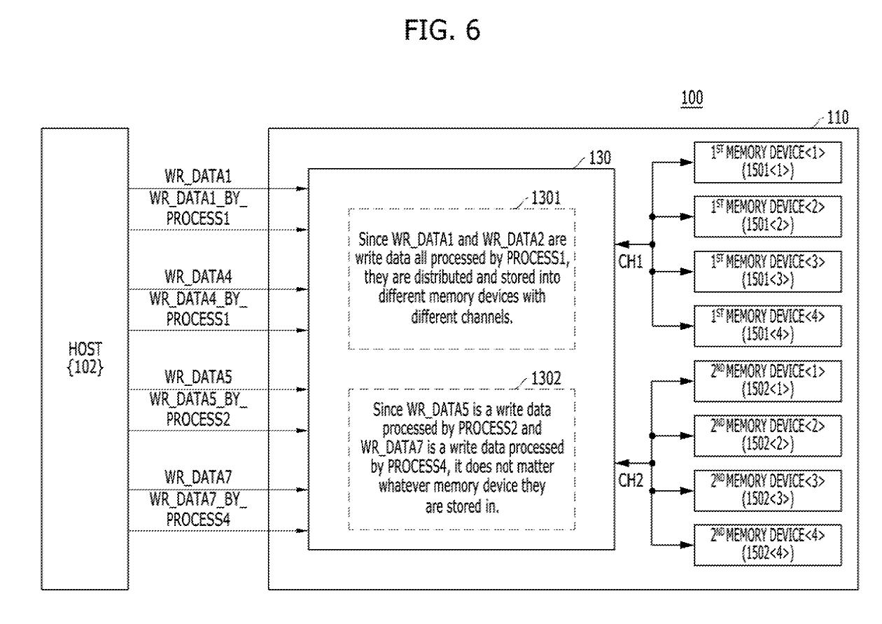

FIG. 6 illustrates an operation of the memory system 110 of FIG. 1, according to an embodiment of the present invention.

Referring to FIGS. 1, 5 and 6, the memory system 110 may include a plurality of memory device groups, for example, first and second memory groups 1501<1:4> and 1502<1:4>. Herein, each of the memory device groups 1501<1:4> and 1502<1:4> includes a plurality of memory devices. For example, the first memory device group includes first to fourth memory devices 1501<1:4> and the second memory device group includes first to fourth memory devices 1502<1:4>.

The first memory device group 1501<1:4> may be coupled to a controller 130 through a first channel CH1.

The second memory device group 1502<1:4> may be coupled to the controller 130 through a second channel CH2.

The memory system 110 may store data in the first and second memory device groups 1501<1:4> and 1502<1:4> according to an interleaving scheme.

When the memory system 110 stores the write data WR_DATA1, WR_DATA4, WR_DATA5 and WR_DATA7 in the memory device groups 1501<1:4> and 1502<1:4>, the memory system 110 defines the physical storage positions of the write data WR_DATA1, WR_DATA4, WR_DATA5 and WR_DATA7 by the interleaving scheme based on the write process data WR_DATA1-BY-PROCESS1, WR_DATA4-BY-PROCESS1, WR_DATA5-BY-PROCESS2 and WR_DATA7-BY-PROCESS4.

To be specific, when the first process data WR_DATA1-BY-PROCESS1 corresponding to the first write data WR_DATA1 is detected, the controller 130 may recognize that the first write data WR_DATA1 is processed by the first processor PROCESS1. Also, when the fourth write process data WR_DATA4-BY-PROCESS1 corresponding to the fourth write data WR_DATA4 is detected, the controller 130 may recognize that the fourth write data WR_DATA4 is processed by the first processor PROCESS1. Also, when the fifth write process data WR_DATA5-BY-PROCESS2 corresponding to the fifth write data WR_DATA5 is detected, the controller 130 of the memory system 110 may recognize that the fifth write data WR_DATA5 is processed by the second processor PROCESS2. Also, when the seventh write process data WR_DATA7-BY-PROCESS4 corresponding to the seventh write data WR_DATA7 is detected, the controller 130 of the memory system 110 may recognize that the seventh write data WR_DATA7 is processed by the fourth processor PROCESS4.

The memory system 110 stores the write data, which are processed by the same processor, into different memory devices of the memory device groups 1501<1:4> and 1502<1:4> by the Interleaving scheme based on the write process data WR_DATA1-BY-PROCESS1, WR_DATA4-BY-PROCESS1, WR_DATA5-BY-PROCESS2 and WR_DATA7-BY-PROCESS4. To this end, the memory system 110 defines the physical storage positions of the write data WR_DATA1, WR_DATA4, WR_DATA5 and WR_DATA7 by the interleaving scheme (refer to ‘1301’ of FIG. 6).

For example, the first process data WR_DATA1-BY-PROCESS1 and the fourth write process data WR_DATA4-BY-PROCESS1 indicate that the first write data WR_DATA1 and the fourth write data WR_DATA4 are all processed by the first processor PROCESS1. Therefore, the first write data WR_DATA1 and the fourth write data WR_DATA4 are stored into separate memory devices through different channels. In other words, when the first write data WR_DATA1 is stored in the first memory device group 1501<1:4>, the fourth write data WR_DATA4 is stored in the second memory device group 1502<1:4>. Conversely, when the first write data WR_DATA1 is stored in the second memory device group 1502<1:4>, the fourth write data WR_DATA4 is stored in the first memory device group 1501<1:4>.

Also, the memory system 110 may store data processed by different processors into the same memory device or different memory devices without the interleaving scheme (refer to ‘1302’ of FIG. 6).

For example, the fifth write process data WR_DATA5-BY-PROCESS2 and the seventh write process data WR_DATA7-BY-PROCESS4 indicate that the fifth write data WR_DATA5 is processed by the second processor PROCESS2 and the seventh write data WR_DATA7 is processed by the fourth processor PROCESS4. Therefore, the memory system 110 may store the fifth and seventh write data WR_DATA5 and WR_DATA7 into the same memory device or different memory devices in the first and second memory device groups 1501<1:4> and 1502<1:4> without the Interleaving scheme.

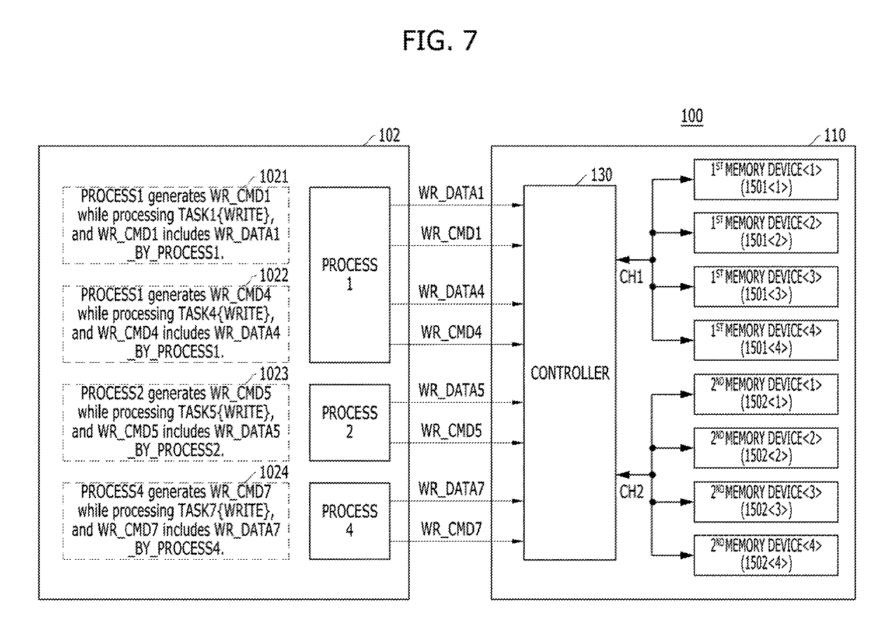

FIG. 7 illustrates an operation between the host 102 and the memory system 110 of FIG. 1.

Referring to FIGS. 5 to 7, the host 102 generates write commands WR_CMD1, WR_CMD4, WR_CMD5 and WR_CMD7 for controlling a write operation of the memory system 110 in the course of processing the write tasks TASK1{WRITE}, TASK4{WRITE}, TASK5{WRITE}, and TASK7{WRITE} among a plurality of tasks TASK1{WRITE}, TASK2{READ}, TASK3{ETC}, TASK4{WRITE}, TASK5{WRITE}, TASK6{ETC} and TASK7{WRITE}.

Herein, the write commands WR_CMD1, WR_CMD4, WR_CMD5 and WR_CMD7 generated in the host 102 include the write process data WR_DATA1-BY-PROCESS1, WR_DATA4-BY-PROCESS1, WR_DATA5-BY-PROCESS2, and WR_DATA7-BY-PROCESS4.

For example, the first write command WR_CMD1 that is generated while the first processor PROCESS1 processes the first task TASK1{WRITE} among the write commands WR_CMD1, WR_CMD4, WR_CMD5 and WR_CMD7 includes the first process data WR_DATA1-BY-PROCESS1 which represents that the first write data WR_DATA1 is generated by the first processor PROCESS1. Also, the fourth write command WR_CMD4 that is generated while the first processor PROCESS1 processes the fourth task TASK4{WRITE} includes the fourth write process data WR_DATA4-BY-PROCESS1 which represents that the fourth write data WR_DATA4 is generated by the first processor PROCESS1. Also, the fifth write command WR_CMD5 that is generated while the second processor PROCESS2 processes the fifth task TASK5{WRITE} includes the fifth write process data WR_DATA5-BY-PROCESS2 which represents that the fifth write data WR_DATA5 is generated by the second processor PROCESS2. Also, the seventh write command WR_CMD7 that is generated while the fourth processor PROCESS4 processes the seventh task TASK7{WRITE} includes the seventh write process data WR_DATA7-BY-PROCESS4 which represents that the seventh write data WR_DATA7 is generated by the fourth processor PROCESS4.

The write commands WR_CMD1, WR_CMD4, WR_CMD5 and WR_CMD7 generated in the inside of the host 102 are transferred to the memory system 110 along with the write data WR_DATA1, WR_DATA4, WR_DATA5 and WR_DATA7.

When the memory system 110 receives the write commands WR_CMD1, WR_CMD4, WR_CMD5 and WR_CMD7 and the write data WR_DATA1, WR_DATA4, WR_DATA5 and WR_DATA7 from the host 102, the memory system 110 detects the write process data WR_DATA1-BY-PROCESS1, WR_DATA4-BY-PROCESS1, WR_DATA5-BY-PROCESS2, and WR_DATA7-BY-PROCESS4 included in the write commands WR_CMD1, WR_CMD4, WR_CMD5 and WR_CMD7, and stores the write data corresponding to the tasks that are processed by the same processor among the write tasks TASK1{WRITE}, TASK4{WRITE}, TASK5{WRITE}, and TASK7{WRITE} into at least two or more different memory devices of the first and second memory device groups 1501<1:4> and 1502<1:4> according to the interleaving scheme.

For example, when the memory system 110 detects the first process data WR_DATA1-BY-PROCESS1 that is included in the first write command WR_CMD1, it may recognize that the first write data WR_DATA1 is processed by the first processor PROCESS1. Also, when the memory system 110 detects the fourth write process data WR_DATA4-BY-PROCESS1 that is included in the fourth write command WR_CMD4, it may recognize that the fourth write data WR_DATA4 is processed by the first processor PROCESS1. Also, when the memory system 110 detects the fifth write process data WR_DATA5-BY-PROCESS2 that is included in the fifth write command WR_CMD5, it may recognize that the fifth write data WR_DATA5 is processed by the second processor PROCESS2. Also, when the memory system 110 detects the seventh write process data WR_DATA7-BY-PROCESS4 that is included in the seventh write command WR_CMD7, it may recognize that the seventh write data WR_DATA7 is processed by the fourth processor PROCESS4.

Therefore, the memory system 110 stores the write data, which are processed by the same processor, into different memory devices of the memory device groups 1501<1:4> and 1502<1:4> by the interleaving scheme based on the write process data WR_DATA1-BY-PROCESS1, WR_DATA4-BY-PROCESS1, WR_DATA5-BY-PROCESS2 and WR_DATA7-BY-PROCESS4. To this end, the memory system 110 defines the physical storage positions of the write data WR_DATA1, WR_DATA4, WR_DATA5 and WR_DATA7 by the interleaving scheme.

For example, the first write data WR_DATA1 and the fourth write data WR_DATA4 processed by the first processor PROCESS1 are stored into separate memory devices through different channels according to the interleaving scheme. In other words, when the first write data WR_DATA1 is stored in the first memory device group 1501<1:4>, the fourth write data WR_DATA4 is stored in the second memory device group 1502<1:4>. Conversely, when the first write data WR_DATA1 is stored in the second memory device group 1502<1:4>, the fourth write data WR_DATA4 is stored in the first memory device group 1501<1:4>.

On the other hand, the fifth write data WR_DATA5 processed by the second processor PROCESS2 and the seventh write data WR_DATA7 processed by the fourth processor PROCESS4 may be stored into any one or more memory devices of the first and second memory device groups 1501<1:4> and 1502<1:4> without the interleaving scheme.

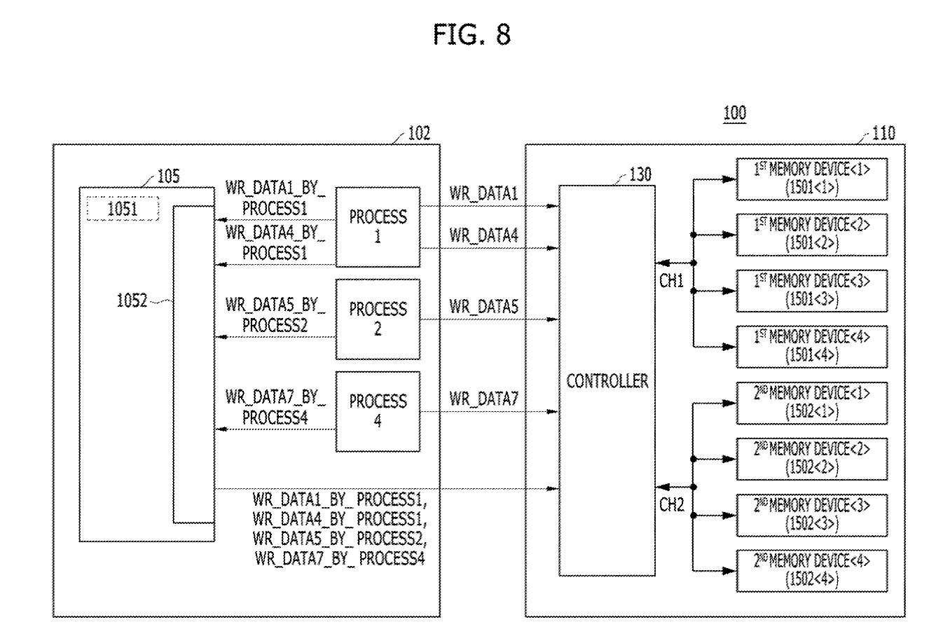

FIG. 8 illustrates an operation between the host 102 and the memory system 110 of FIG. 1.

Referring to FIGS. 5, 6 and 8, the host 102 includes a main memory 105 divided into first and second regions 1502 and 1501. The first region 1052 may store the write process data WR_DATA1-BY-PROCESS1, WR_DATA4-BY-PROCESS1, WR_DATA5-BY-PROCESS2, and WR_DATA7-BY-PROCESS4, and may be accessed by the memory system 110. The second region 1501 may store internal data (not shown) used in the inside of the host 102 to process a plurality of tasks TASK1{WRITE}, TASK2{READ}, TASK3{ETC}, TASK4{WRITE}, TASK5{WRITE}, TASK6{ETC} and TASK7{WRITE}.

Differently from the embodiment of FIG. 7, the host 102 may store the write process data WR_DATA1-BY-PROCESS1, WR_DATA4-BY-PROCESS1, WR_DATA5-BY-PROCESS2, and WR_DATA7-BY-PROCESS4, and provide the memory system 110 with the write commands WR_CMD1, WR_CMD4, WR_CMD5 and WR_CMD7 along with the write data WR_DATA1, WR_DATA4, WR_DATA5 and WR_DATA7 without providing the write process data WR_DATA1-BY-PROCESS1, WR_DATA4-BY-PROCESS1, WR_DATA5-BY-PROCESS2, and WR_DATA7-BY-PROCESS4. Upon reception of the write data WR_DATA1, WR_DATA4, WR_DATA5 and WR_DATA7, the controller 130 may recognize that the write data WR_DATA1, WR_DATA4, WR_DATA5 and WR_DATA7 are processed by the first, second and fourth processors PROCESS1, PROCESS2 and PROCESS4 by accessing the first region 1502 of the main memory 105 in the host 102 and reading the write process data WR_DATA1-BY-PROCESS1, WR_DATA4-BY-PROCESS1, WR_DATA5-BY-PROCESS2, and WR_DATA7-BY-PROCESS4 based on the provided write data WR_DATA1, WR_DATA4, WR_DATA5 and WR_DATA7.

The subsequent steps of the memory system 110 are the same as described with reference to FIG. 7.

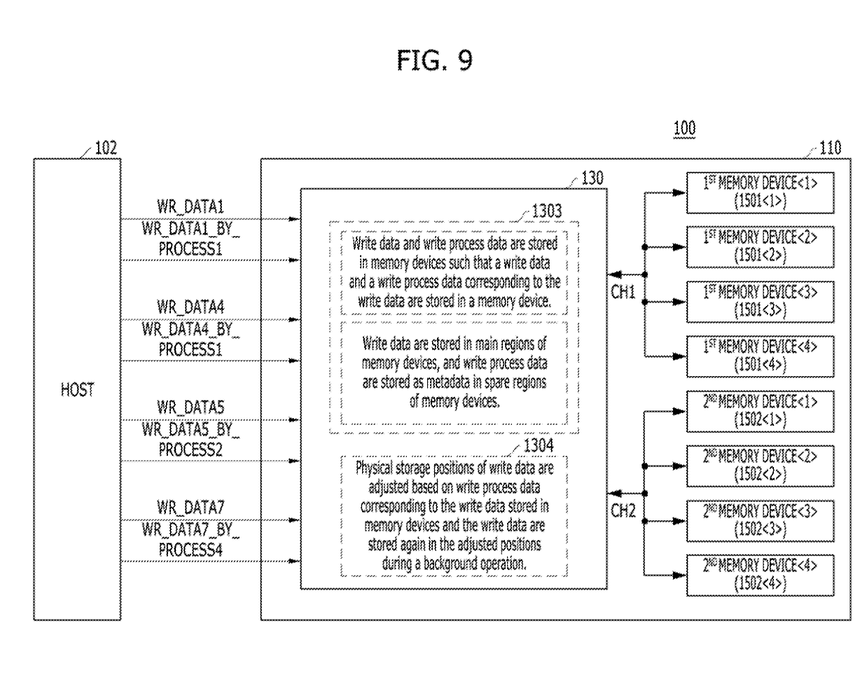

FIG. 9 illustrates an operation of the memory system 110 of FIG. 1.

Referring to FIGS. 1, 5 and 9, the memory system 110 stores the write data WR_DATA1, WR_DATA4, WR_DATA5 and WR_DATA7 and the write process data WR_DATA1-BY-PROCESS1, WR_DATA4-BY-PROCESS1, WR_DATA5-BY-PROCESS2, and WR_DATA7-BY-PROCESS4 by a unit of a pair of the write data and the corresponding write process data in the memory device groups 1501<1:4> and 1502<1:4>.

To be specific, respective pairs of the first write data WR_DATA1 and the first write process data WR_DATA1-BY-PROCESS1, the fourth write data WR_DATA4 and the fourth process data WR_DATA4-BY-PROCESS1, the fifth write data WR_DATA5 and the fifth write process data WR_DATA5-BY-PROCESS2, and the seventh write data WR_DATA7 and the seventh write process data WR_DATA7-BY-PROCESS4 may be stored in a respectively selected memory device in the first and second memory device groups 1501<1:4> and 1502<1:4>.

Referring to FIG. 9, each memory device of the first and second memory device groups 1501<1:4> and 1502<1:4> may be divided into a main region and a spare region. The provided write data WR_DATA1, WR_DATA4, WR_DATA5 and WR_DATA7 are stored in the main region, whereas the write process data WR_DATA1-BY-PROCESS1, WR_DATA4-BY-PROCESS1, WR_DATA5-BY-PROCESS2, and WR_DATA7-BY-PROCESS4 are stored in the spare region as metadata.

As described with reference to FIG. 6, when the memory system 110 stores the write data WR_DATA1, WR_DATA4, WR_DATA5 and WR_DATA7 in the memory device groups 1501<1:4> and 1502<1:4>, the memory system 110 defines the physical storage positions of the write data WR_DATA1 and WR_DATA4 by the interleaving scheme based on the write process data WR_DATA1-BY-PROCESS1 and WR_DATA4-BY-PROCESS1. The memory system 110 stores the write data WR_DATA1 and WR_DATA4, which are processed by the same processor PROCESS1, into different memory devices of the memory device groups 1501<1:4> and 1502<1:4> by the interleaving scheme based on the write process data WR_DATA1-BY-PROCESS1 and WR_DATA4-BY-PROCESS1. To this end, the memory system 110 defines the physical storage positions of the write data WR_DATA1 and WR_DATA4 by the interleaving scheme. Also, the memory system 110 may store write data WR_DATA5 and WR_DATA7 processed by different processors PROCESS2 and PROCESS4 into the same memory device or different memory devices based on the write process data WR_DATA5-BY-PROCESS2 and WR_DATA7-BY-PROCESS4 without the interleaving scheme.

For example, in the write operation of the memory system 110, the first write data WR_DATA1 and the first process data WR_DATA1-BY-PROCESS1 may be stored together in a first memory device 1501<1> of the first memory device group 1501<1:4>. Also, the fourth write data WR_DATA4 and the fourth process data WR_DATA4-BY-PROCESS1 may be stored together in a second memory device 1501<2> of the second memory device group 1501<1:4>. Also, the fifth write data WR_DATA5 and the fifth write process data WR_DATA5-BY-PROCESS2 may be stored together in a third memory device 1501<3> of the first memory device group 1501<1:4>. Also, the seventh write data WR_DATA7 and the seventh write process data WR_DATA7-BY-PROCESS4 may be stored together in a fourth memory device 1501<4> of the first memory device group 1501<1:4>. As such, the first and fourth write data WR_DATA1 and WR_DATA4 as well as the corresponding first and fourth write process data WR_DATA1-BY-PROCESS1 and WR_DATA4-BY-PROCESS1 may be stored according to the interleaving scheme while the fifth and seventh write data WR_DATA5 and WR_DATA7 as well as the corresponding fifth and seventh write process data WR_DATA5-BY-PROCESS2 and WR_DATA7-BY-PROCESS4 may be randomly stored without the interleaving scheme.

To this end, upon reception of the write data WR_DATA1, WR_DATA4, WR_DATA5 and WR_DATA7 and the write process data WR_DATA1-BY-PROCESS1, WR_DATA4-BY-PROCESS1, WR_DATA5-BY-PROCESS2 and WR_DATA7-BY-PROCESS4, the memory system 110 may temporarily store the write data WR_DATA1, WR_DATA4, WR_DATA5 and WR_DATA7 and the write process data WR_DATA1-BY-PROCESS1, WR_DATA4-BY-PROCESS1, WR_DATA5-BY-PROCESS2, and WR_DATA7-BY-PROCESS4 by the unit of the pair in randomly selected memory devices of the memory device groups 1501<1:4> and 1502<1:4>. After that, during a background operation, the memory system 110 may adjust the storage location of the respective pairs of the write data and the corresponding write process data according to the interleaving scheme as described above, and move the respective pairs of the write data and the write process data according to the adjustment of the storage location.

For example, the background operation may be the garbage collection operation, the wear leveling operation, or the disk defragmentation operation.

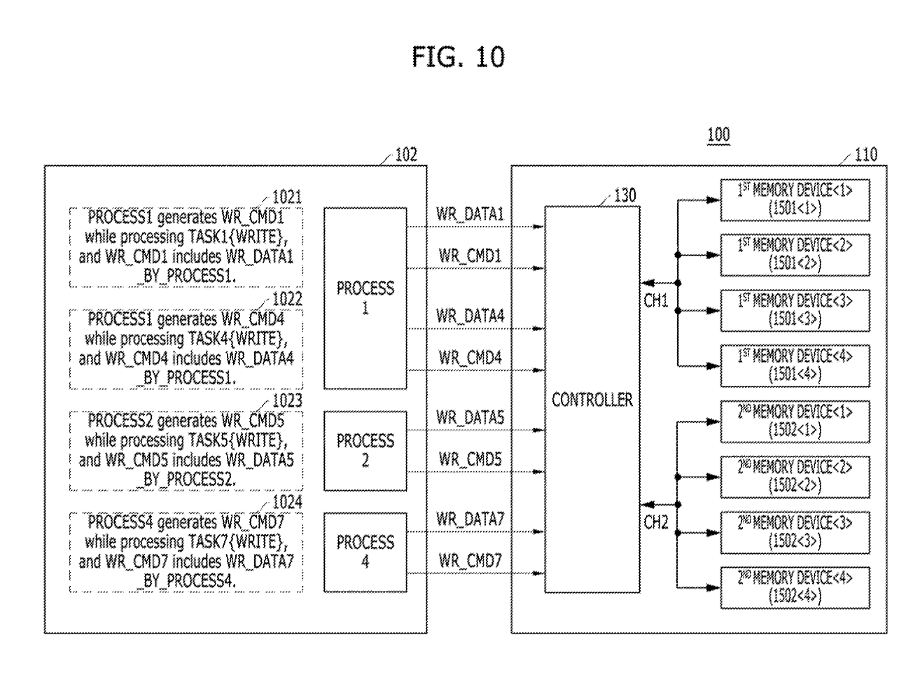

FIG. 10 illustrates an operation between the host 102 and the memory system 110 of FIG. 1.

The operation of FIG. 10 is the same as the operation of FIG. 7 except that the memory system 110, when the memory system 110 of FIG. 10 receives the write commands WR_CMD1, WR_CMD4, WR_CMD5 and WR_CMD7 and the write data WR_DATA1, WR_DATA4, WR_DATA5 and WR_DATA7 from the host 102, separates the write process data WR_DATA1-BY-PROCESS1, WR_DATA4-BY-PROCESS1, WR_DATA5-BY-PROCESS2, and WR_DATA7-BY-PROCESS4 from the write commands WR_CMD1, WR_CMD4, WR_CMD5 and WR_CMD7, and stores the separated write process data WR_DATA1-BY-PROCESS1, WR_DATA4-BY-PROCESS1, WR_DATA5-BY-PROCESS2, and WR_DATA7-BY-PROCESS4 as metadata in the memory device groups 1501<1:4> and 1502<1:4> along with the write data WR_DATA1, WR_DATA4, WR_DATA5 and WR_DATA7. Subsequently, the memory system 110 reads the metadata or the write process data WR_DATA1-BY-PROCESS1, WR_DATA4-BY-PROCESS1, WR_DATA5-BY-PROCESS2, and WR_DATA7-BY-PROCESS4 corresponding to the write data WR_DATA1, WR_DATA4, WR_DATA5 and WR_DATA7 that are stored in the memory device groups 1501<1:4> and 1502<1:4> during the background operation to identify the write data corresponding to the tasks that are processed by the same processor among the write tasks TASK1{WRITE}, TASK4{WRITE}, TASK5{WRITE}, and TASK7{WRITE}. The memory system 110 then stores the detected write data in at least two or more different memory devices of the first and second memory device groups 1501<1:4> and 1502<1:4> according to the Interleaving scheme.

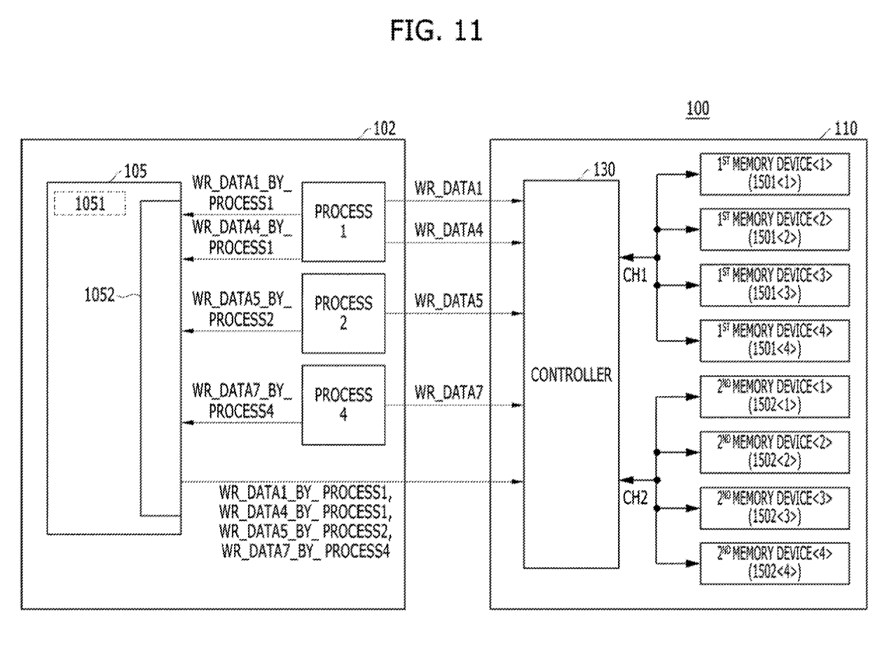

FIG. 11 illustrates an operation between the host 102 and the memory system 110 of FIG. 1.

Similarly to the data processing system 100 of FIG. 8, the host 102 of FIG. 11 includes the main memory 105 divided into the first and second regions 1502 and 1501.

The operation of FIG. 11 is the same as the operation of FIG. 8 except that the controller 130 may store the write process data WR_DATA1-BY-PROCESS1, WR_DATA4-BY-PROCESS1, WR_DATA5-BY-PROCESS2, and WR_DATA7-BY-PROCESS4, as well as the write data WR_DATA1, WR_DATA4, WR_DATA5 and WR_DATA7, in the first and second memory device groups 1501<1:4> and 1502<1:4> by reading the write process data WR_DATA1-BY-PROCESS1, WR_DATA4-BY-PROCESS1, WR_DATA5-BY-PROCESS2, and WR_DATA7-BY-PROCESS4 stored in the first region 1502 of the host 102 based on the write data WR_DATA1, WR_DATA4, WR_DATA5 and WR_DATA7 provided from the host 102 to the memory system 110. Subsequently, the memory system 110 reads the metadata or the write process data WR_DATA1-BY-PROCESS1, WR_DATA4-BY-PROCESS1, WR_DATA5-BY-PROCESS2, and WR_DATA7-BY-PROCESS4 corresponding to the write data WR_DATA1, WR_DATA4, WR_DATA5 and WR_DATA7 that are stored in the memory device groups 1501<1:4> and 1502<1:4> during the background operation to identify the write data corresponding to the tasks that are processed by the same processor among the write tasks TASK1{WRITE}, TASK4{WRITE}, TASK5{WRITE}, and TASK7{WRITE}. The memory system 110 then re-stores the write data in at least two or more different memory devices of the first and second memory device groups 1501<1:4> and 1502<1:4> according to the interleaving scheme.

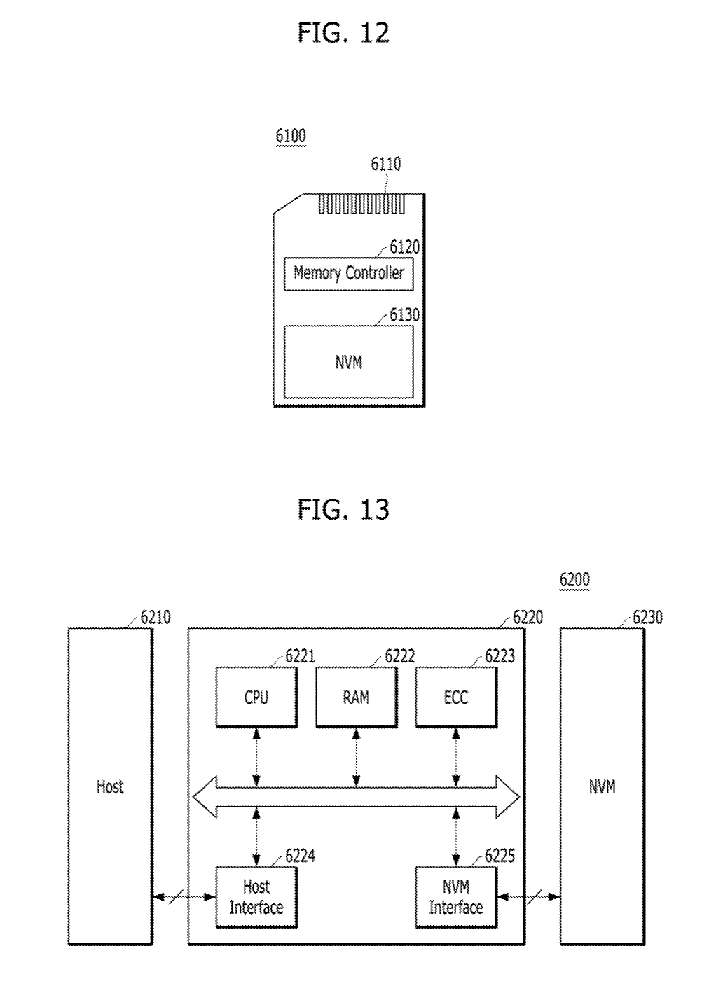

FIG. 12 illustrates a memory card system including a memory system, according to the embodiment of the present invention.

Referring to FIG. 12, a memory card system 6100 includes a memory controller 6120, a memory device 6130, and a connector 6110.

In detail, the memory controller 6120 may be connected with the memory device 6130 and may access the memory device 6130. In some embodiments, the memory device 6130 may be implemented with a nonvolatile memory (NVM). For example, the memory controller 6120 may control read, write, erase and background operations for the memory device 6130. The memory controller 6120 may provide an interface between the memory device 6130 and a host (not shown), and may drive a firmware for controlling the memory device 6130. That is to say, the memory controller 6120 may correspond to the controller 130 in the memory system 110 described above with reference to FIG. 1, and the memory device 6130 may correspond to the memory device 150 in the memory system 110 described above with reference to FIG. 1.

Therefore, the memory controller 6120 may include components such as a random access memory (RAM), a processing unit, a host interface, a memory interface and an error correction unit as shown in FIG. 1.

The memory controller 6120 may communicate with an external device (for example, the host 102 described above with reference to FIG. 1), through the connector 6110. For example, as described above with reference to FIG. 1, the memory controller 6120 may be configured to communicate with the external device through at least one of various communication protocols such as universal serial bus (USB), multimedia card (MMC), embedded MMC (eMMC), peripheral component interconnection (PCI), PCI express (PCIe), Advanced Technology Attachment (ATA), Serial-ATA, Parallel-ATA, small computer system interface (SCSI), enhanced small disk interface (ESDI), Integrated Drive Electronics (IDE), Firewire, universal flash storage (UFS), wireless-fidelity (WI-FI) and Bluetooth. Accordingly, the memory system and the data processing system according to the embodiment may be applied to wired/wireless electronic appliances, in particular, a mobile electronic appliance.

The memory device 6130 may be implemented with a nonvolatile memory. For example, the memory device 6130 may be implemented with various nonvolatile memory devices such as an electrically erasable and programmable ROM (EPROM), a NAND flash memory, a NOR flash memory, a phase-change RAM (PRAM), a resistive RAM (ReRAM), a ferroelectric RAM (FRAM) and a spin torque transfer magnetic RAM (STT-MRAM).

The memory controller 6120 and the memory device 6130 may be integrated into a single semiconductor device. For example, the memory controller 6120 and the memory device 6130 may construct a solid state driver (SSD) by being integrated into a single semiconductor device. Also, the memory controller 6120 and the memory device 6130 may construct a memory card such as a PC card (PCMCIA: Personal Computer Memory Card International Association), a compact flash card (CF), a smart media card (SM and SMC), a memory stick, a multimedia card (MMC, RS-MMC, MMCmicro and eMMC), an SD card (e.g., SD, miniSD, microSD and SDHC) and a universal flash storage (UFS).

FIG. 13 is a diagram illustrating a data processing system including the memory system according to an embodiment of the present invention.

Referring to FIG. 13, a data processing system 6200 includes a memory device 6230 which may be implemented with at least one nonvolatile memory (NVM) and a memory controller 6220 which controls the memory device 6230. The data processing system 6200 may be a storage medium such as a memory card (e.g., CF, SD and microSD), as described above with reference to FIG. 1. The memory device 6230 may correspond to the memory device 150 in the memory system 110 described above with reference to FIG. 1, and the memory controller 6220 may correspond to the controller 130 in the memory system 110 described above with reference to FIG. 1.

The memory controller 6220 may control read, write and erase operations for the memory device 6230 in response to requests from a host 6210. The memory controller 6220 may include a central processing unit (CPU) 6221, a random access memory (RAM) as a buffer memory 6222, an error correction code (ECC) circuit 6223, a host interface 6224, and an NVM interface as a memory interface 6225.

The CPU 6221 may control general operations for the memory device 6230 such as read, write, file system management, bad page management, and so forth. The RAM 6222 may operate according to control of the CPU 6221, and may be used as a work memory, a buffer memory, a cache memory, or the like. In the case where the RAM 6222 is used as a work memory, data processed by the CPU 6221 is temporarily stored in the RAM 6222. In the case where the RAM 6222 is used as a buffer memory, the RAM 6222 is used to buffer data to be transmitted from the host 6210 to the memory device 6230 or from the memory device 6230 to the host 6210. In the case where the RAM 6222 is used as a cache memory, the RAM 6222 may be used to enable the memory device 6230 with a low speed to operate at a high speed.

The ECC circuit 6223 corresponds to the ECC unit 138 of the controller 130 described above with reference to FIG. 1. As described above with reference to FIG. 1, the ECC circuit 6223 may generate an error correction code (ECC) for correcting a fall bit or an error bit in the data received from the memory device 6230. Also, the ECC circuit 6223 may perform error correction encoding for data to be provided to the memory device 6230, and may generate data added with parity bits. The parity bits may be stored in the memory device 6230. The ECC circuit 6223 may perform error correction decoding for data outputted from the memory device 6230. At this time, the ECC circuit 6223 may correct errors by using the parity bits. For example, as described above with reference to FIG. 1, the ECC circuit 6223 may correct errors by using various coded modulations such as of a low density parity check (LDPC) code, a Bose-Chaudhuri-Hocquenghem (BCH) code, a turbo code, a Reed-Solomon (RS) code, a convolution code, a recursive systematic code (RSC), a trellis-coded modulation (TCM) and a block coded modulation (BCM).

The memory controller 6220 transmits and receives data to and from the host 6210 through the host interface 6224, and transmits and receives data to and from the memory device 6230 through the NVM interface 6225. The host interface 6224 may be connected with the host 6210 through at least one of various interface protocols such as a parallel advanced technology attachment (PATA) bus, a serial advanced technology attachment (SATA) bus, a small computer system interface (SCSI), a universal serial bus (USB), a peripheral component interconnection express (PCIe) or a NAND interface. Further, as a wireless communication function or a mobile communication protocol such as wireless fidelity (WI-FI) or long term evolution (LTE) is realized, the memory controller 6220 may transmit and receive data by being connected with an external device such as the host 6210 or another external device other than the host 6210. Specifically, as the memory controller 6220 is configured to communicate with an external device through at least one among various communication protocols, the memory system and the data processing system according to the embodiment may be applied to wired/wireless electronic appliances, in particular, a mobile electronic appliance.

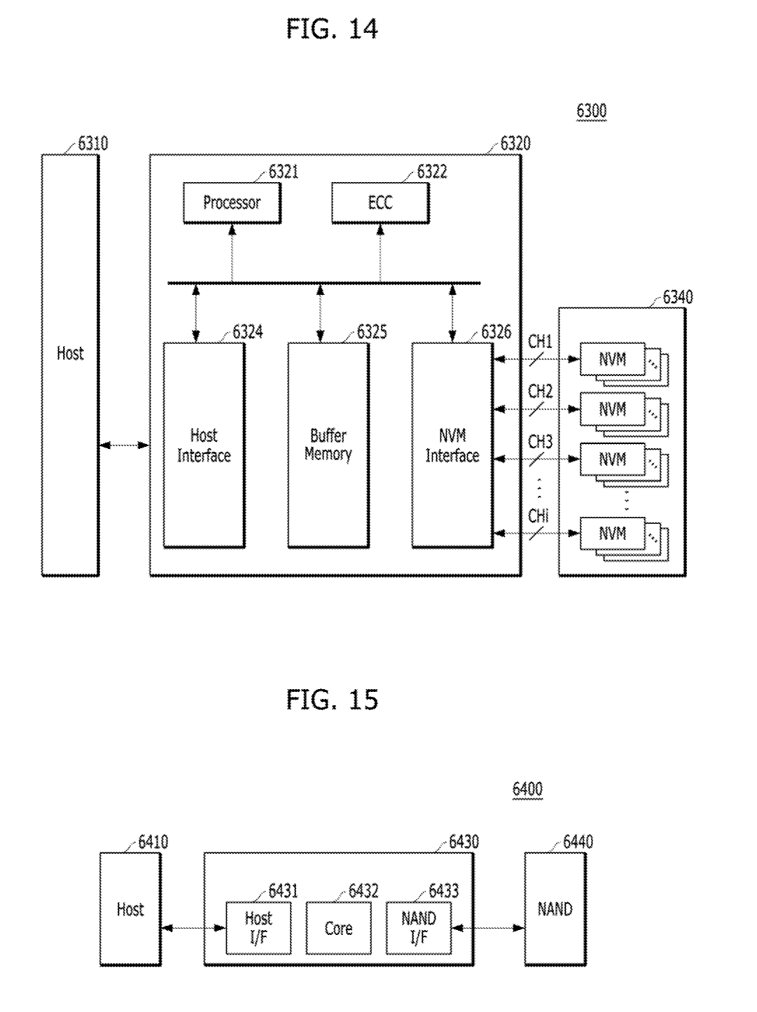

FIG. 14 is a diagram illustrating a solid state drive (SSD) to which the memory system is applied, according to an embodiment of the present invention.

Referring to FIG. 14, an SSD 6300 may include a memory device 6340 which may include a plurality of nonvolatile memories, and a controller 6320. The controller 6320 may correspond to the controller 130 in the memory system 110 described above with reference to FIG. 1, and the memory device 6340 may correspond to the memory device 150 in the memory system 110 described above with reference to FIG. 1.

In detail, the controller 6320 may be connected with the memory device 6340 through a plurality of channels CH1 to CHi. The controller 6320 may include a processor 6321, a buffer memory 6325, an error correction code (ECC) circuit 6322, a host interface 6324, and a nonvolatile memory (NVM) interface 6326 as a memory interface.

The buffer memory 6325 temporarily stores data received from a host 6310 or data received from a plurality of nonvolatile memories NVMs included in the memory device 6340, or temporarily stores metadata of the plurality of nonvolatile memories NVMs. For example, the metadata includes map data including mapping tables. The buffer memory 6325 may be implemented with a volatile memory such as, but not limited to, a dynamic random access memory (DRAM), a synchronous dynamic random access memory (SDRAM), a double data rate (DDR) SDRAM, a low power double data rate (LPDDR) SDRAM and a graphic random access memory (GRAM) or a nonvolatile memory such as, but not limited to, a ferroelectric random access memory (FRAM), a resistive random access memory (ReRAM), a spin-transfer torque magnetic random access memory (STT-MRAM) and a phase change random access memory (PRAM). While it is illustrated in FIG. 10, for the sake of convenience in explanation, that the buffer memory 6325 is disposed inside the controller 6320, it is to be noted that the buffer memory 6325 may be disposed outside the controller 6320.

The ECC circuit 6322 calculates error correction code values of data to be programmed in the memory device 6340 in a program operation, performs an error correction operation for data read from the memory device 6340, based on the error correction code values, in a read operation, and performs an error correction operation for data recovered from the memory device 6340 in a recovery operation for failed data.

The host interface 6324 provides an interface function with respect to an external device such as the host 6310. The nonvolatile memory interface 6326 provides an interface function with respect to the memory device 6340 which is connected through the plurality of channels CH1, CH2, CH3, . . . and CHi.

As a plurality of SSDs 6300 to each of which the memory system 110 described above with reference to FIG. 1 is applied are used, a data processing system such as a redundant array of independent disks (RAID) system may be implemented. In the RAID system, the plurality of SSDs 6300 and an RAID controller for controlling the plurality of SSDs 6300 may be included. In the case of performing a program operation by receiving a write command from the host 6310, the RAID controller may select at least one memory system (that is, at least one SSD 6300) in response to the RAID level information of the write command received from the host 6310, among a plurality of RAID levels (that is, the plurality of SSDs 6300) and may output data corresponding to the write command, to the selected SSD 6300. Also, in the case of performing a read operation by receiving a read command from the host 6310, the RAID controller may select at least one memory system (that is, at least one SSD 6300) in response to the RAID level information of the write command received from the host 6310, among the plurality of RAID levels (that is, the plurality of SSDs 6300), and may provide data outputted from the selected SSD 6300, to the host 6310.

FIG. 15 is a diagram illustrating an embedded multimedia card (eMMC) including a memory system, according to an embodiment of the present invention.

Referring to FIG. 15, an eMMC 6400 includes a memory device 6440 which is implemented with at least one NAND flash memory, and a controller 6430. The controller 6430 may correspond to the controller 130 in the memory system 110 described above with reference to FIG. 1, and the memory device 6440 may correspond to the memory device 150 in the memory system 110 described above with reference to FIG. 1.

In detail, the controller 6430 may be connected with the memory device 6440 through a plurality of channels. The controller 6430 may include a core 6432, a host interface 6431, and a memory interface such as a NAND interface 6433.

The core 6432 may control general operations of the eMMC 6400. The host interface 6431 may provide an interface function between the controller 6430 and a host 6410. The NAND interface 6433 may provide an interface function between the memory device 6440 and the controller 6430. For example, the host interface 6431 may be a parallel interface such as an MMC interface, as described above with reference to FIG. 1, and may be a serial interface such as a ultra high speed class 1(UHS-I)/UHS class 2(UHS-II) and a universal flash storage (UFS) interface.

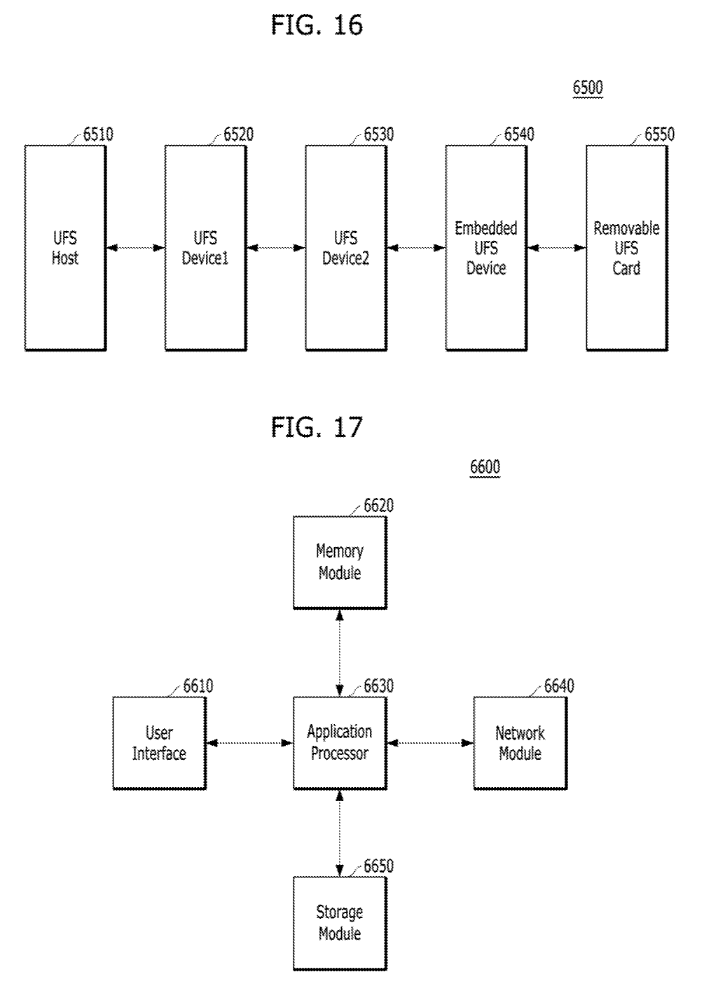

FIG. 16 illustrates a universal flash storage (UFS) to which a memory system according to an embodiment of the present invention is applied.

Referring to FIG. 16, a UFS system 6500 may include a UFS host 6510, a plurality of UFS devices 6520 and 6530, an embedded UFS device 6540, and a removable UFS card 6550. The UFS host 6510 may be an application processor of wired/wireless electronic appliances, in particular, a mobile electronic appliance.

The UFS host 6510, the UFS devices 6520 and 6530, the embedded UFS device 6540 and the removable UFS card 6550 may respectively communicate with external devices such as wired/wireless electronic appliances (in particular, a mobile electronic appliance), through a UFS protocol. The UFS devices 6520 and 6530, the embedded UFS device 6540 and the removable UFS card 6550 may be implemented with the memory system 110 described above with reference to FIG. 1, in particular, as the memory card system 6100 described above with reference to FIG. 8. The embedded UFS device 6540 and the removable UFS card 6550 may communicate through another protocol other than the UFS protocol. For example, the embedded UFS device 6540 and the removable UFS card 6550 may communicate through various card protocols such as, but not limited to, USB flash drives (UFDs), multimedia card (MMC), secure digital (SD), mini SD and Micro SD.

FIG. 17 illustrates a user system 6600 to which the memory system according to the embodiment is applied.

Referring to FIG. 17, a user system 6600 may include an application processor 6630, a memory module 6620, a network module 6640, a storage module 6650, and a user interface 6610.

In detail, the application processor 6630 may drive components included in the user system 6600 and an operating system (OS). For example, the application processor 6630 may include controllers for controlling the components included in the user system 6600, interfaces, graphics engines, and so on. The application processor 6630 may be provided by a system-on-chip (SoC).

The memory module 6620 may operate as a main memory, a working memory, a buffer memory or a cache memory of the user system 6600. The memory module 6620 may include a volatile random access memory such as a dynamic random access memory (DRAM), a synchronous dynamic random access memory (SDRAM), a double data rate (DDR) SDRAM, a DDR2 SDRAM, a DDR3 SDRAM, an LPDDR SDRAM, an LPDDR2 SDRAM and an LPDDR3 SDRAM or a nonvolatile random access memory such as a phase change random access memory (PRAM), a resistive random access memory (ReRAM), a magnetic random access memory (MRAM) and a ferroelectric random access memory (FRAM). For example, the application processor 6630 and the memory module 6620 may be mounted by being packaged on the basis of a package-on-package (POP).

The network module 6640 may communicate with external devices. For example, the network module 6640 may support not only wired communications but also various wireless communications such as code division multiple access (CDMA), global system for mobile communication (GSM), wideband CDMA (WCDMA), CDMA-2000, time division multiple access (TDMA), long term evolution (LTE), worldwide interoperability for microwave access (WIMAX), wireless local area network (WLAN), ultra-wideband (UWB), Bluetooth, wireless display (WI-DI), and so on, and may thereby communicate with wired/wireless electronic appliances, in particular, a mobile electronic appliance. According to this fact, the memory system and the data processing system according to the embodiment may be applied to wired/wireless electronic appliances. The network module 6640 may be included in the application processor 6630.

The storage module 6650 may store data such as data received from the application processor 6630, and transmit data stored therein, to the application processor 6630. The storage module 6650 may be realized by a nonvolatile semiconductor memory device such as a phase-change RAM (PRAM), a magnetic RAM (MRAM), a resistive RAM (ReRAM), a NAND flash memory, a NOR flash memory and a 3-dimensional NAND flash memory. Also, the storage module 6650 may be provided as a removable storage medium such as a memory card of the user system 6600 and an external drive. That is to say, the storage module 6650 may correspond to the memory system 110 described above with reference to FIG. 1, and may be realized as the SSD, eMMC and UFS described above with reference to FIGS. 14 to 16.

The user interface 6610 may include interfaces for inputting data or commands to the application processor 6630 or for outputting data to an external device. For example, the user interface 6610 may include user input interfaces such as a keyboard, a keypad, a button, a touch panel, a touch screen, a touch pad, a touch ball, a camera, a microphone, a gyroscope sensor, a vibration sensor and a piezoelectric element, and user output interfaces such as a liquid crystal display (LCD), an organic light emitting diode (OLED) display device, an active matrix OLED (AMOLED) display device, a light emitting diode (LED), a speaker and a motor.

In the case where the memory system 110 described above with reference to FIG. 1 is applied to the mobile electronic appliance of the user system 6600 according to an embodiment, the application processor 6630 controls general operations of the mobile electronic appliance, and the network module 6640 as a communication module controls wired/wireless communication with an external device, as described above. The user interface 6610 as the display/touch module of the mobile electronic appliance displays data processed by the application processor 6630 or supports input of data from a touch panel.

According to an embodiment of the present invention, it is possible to move the physical storage positions of write data based on an operation processor into the positions which are accessible in the interleaving method and store the write data therein in a data processing system that is capable of processing a plurality of tasks in parallel by including a plurality of processors.

Also, according to an embodiment of the present invention, even after write data are stored in a plurality of memory devices, it is possible to adjust the physical storage positions of the write data again based on an operation processor into the positions which are accessible in the interleaving method and store the write data therein in the data processing system that is capable of processing a plurality of tasks in parallel by including a plurality of processors. In this way, the efficiency of an interleaving operation may be maximized.

While the present invention has been described with respect to the specific embodiments, it will be apparent to those skilled in the art that various changes and modifications may be made without departing from the spirit and scope of the invention as defined in the following claims.

What is claimed is:

1. A data processing system, comprising:
a host suitable for processing a plurality of tasks in parallel through a plurality of processors included therein, detecting write tasks that generate write data among the plurality of the tasks, and generating write process data which represent which one of the processors processes the respective write tasks; and
a memory system suitable for storing the write data, which are processed by same one of the processors, into a plurality of memory devices thereof according to an interleaving scheme,
wherein the memory system determines based on the write process data whether the write data are processed by the same processor.

2. The data processing system of claim 1, wherein the respective write process data is included in a write commands generated by the host.

3. The data processing system of claim 2,
wherein the plurality of the memory devices are divided into N memory device groups respectively coupled to N channels, and
wherein the memory system stores the write data, which are processed by the same processor, into the memory devices of different ones among the N memory device groups according to an interleaving scheme.

4. The data processing system of claim 1, wherein the host stores the write process data in a part of a main memory used for internal data thereof.

5. The data processing system of claim 4,
wherein the plurality of the memory devices are divided into N memory device groups respectively coupled to N channels, and
wherein the memory system stores the write data, which are processed by the same processor, into the memory devices of different ones among the N memory device groups according to an interleaving scheme.

6. A method for operating a data processing system comprising a host including a plurality of processors, and a memory system including a plurality of memory devices, the method comprising:
processing, by the host, a plurality of tasks in parallel through the processors;
detecting, by the host, write tasks that generate write data among the plurality of the tasks;
generating, by the host, write process data that represent which one of the processors processes the respective write tasks; and
storing, by the memory system, the write data, which are processed by same one of the processors, into a plurality of memory devices thereof according to an interleaving scheme,
wherein the storing of the write data includes determining based on the write process data whether the write data are processed by the same processor.

7. The method of claim 6, wherein the respective write process data is included in a write commands generated by the host.

8. The method of claim 7, wherein
wherein the plurality of the memory devices are divided into N memory device groups respectively coupled to N channels, and
wherein the storing of the write data, which are processed by same one of the processors, is performed to the memory devices of different ones among the N memory device groups according to an interleaving scheme.

9. The method of claim 6, further comprising storing, by the host, the write process data in a part of a main memory used for internal data of the host.

10. The method of claim 9, wherein
wherein the plurality of the memory devices are divided into N memory device groups respectively coupled to N channels, and
wherein the storing of the write data, which are processed by same one of the processors, is performed to the memory devices of different ones among the N memory device groups according to an interleaving scheme.

11. A data processing system, comprising:
a host suitable for processing a plurality of tasks in parallel through a plurality of processors included therein, detecting write tasks that generate write data among the plurality of the tasks, and generating write process data which represent which one of the processors processes the respective write tasks; and
a memory system suitable for storing the write data and the write process data by a unit of a pair of the write data and the corresponding write process data randomly in a plurality of memory devices thereof, and then re-storing the write data, which are processed by same one of the processors, into the memory devices according to an interleaving scheme during a background operation,
wherein the memory system determines based on the write process data whether the write data are processed by the same processor.

12. The data processing system of claim 11, wherein the respective write process data is included in a write commands generated by the host.

13. The data processing system of claim 12,
wherein the plurality of the memory devices are divided into N memory device groups respectively coupled to N channels, and
wherein the memory system stores the write data, which are processed by the same processor, into the memory devices of different ones among the N memory device groups according to an Interleaving scheme.

14. The data processing system of claim 11, wherein the host stores the write process data in a part of a main memory used for internal data thereof.

15. The data processing system of claim 14,
wherein the host provides the write data to the memory system while storing the write data in the part of the main memory, and
wherein the memory system stores the write data and the write process data randomly in the memory devices by reading the write process data from the part of the main memory, and then re-stores the write data, which are processed by same one of the processors, into the memory devices according to the Interleaving scheme during the background operation.

16. The data processing system of claim 14,
wherein the plurality of the memory devices are divided into N memory device groups respectively coupled to N channels, and
wherein the memory system stores the write data, which are processed by the same processor, into the memory devices of different ones among the N memory device groups according to an interleaving scheme.

17. The data processing system of claim 11, wherein the background operation is one of a garbage collection operation, a wear leveling operation, or a data defragmentation operation.

18. A method for operating a data processing system comprising a host including a plurality of processors, and a memory system including a plurality of memory devices, the method comprising:
processing, by the host, a plurality of tasks in parallel through the processors;
detecting, by the host, write tasks that generate write data among the plurality of the tasks;
generating, by the host, write process data that represent which one of the processors processes the respective write tasks;
storing, by the memory system, the write data and the write process data by a unit of a pair of the write data and the corresponding write process data randomly in the memory devices; and
re-storing, by the memory system, the write data, which are processed by same one of the processors, into the memory devices according to an interleaving scheme during a background operation,
wherein the re-storing of the write data includes determining based on the write process data whether the write data are processed by the same processor.

19. The method of claim 18, wherein the respective write process data is included in a write commands generated by the host.

20. The method of claim 19,
wherein the plurality of the memory devices are divided into N memory device groups respectively coupled to N channels, and
wherein the re-storing of the write data, which are processed by same one of the processors, is performed to the memory devices of different ones among the N memory device groups according to an interleaving scheme.

21. The method of claim 18, further comprising storing, by the host, the write process data in a part of a main memory used for internal data of the host.

22. The method of claim 21,
further comprising providing, by the host, the write data to the memory system while storing, by the host, the write data in the part of the main memory,
wherein the storing of the write data and the write process data randomly in the memory devices includes reading, by the memory system, the write process data from the part of the main memory.

23. The method of claim 21,
wherein the plurality of the memory devices are divided into N memory device groups respectively coupled to N channels, and
wherein the re-storing of the write data, which are processed by the same processor, is performed to the memory devices of different ones among the N memory device groups according to an interleaving scheme.

24. The method of claim 18, wherein the background operation is one of a garbage collection operation, a wear leveling operation, or a data defragmentation operation.
